(19) United States
(12) Patent Application Publication
(10) Pub. No.: US 2005/0096448 A1
(43) Pub. Date: May 5, 2005

(54) Increasing syndiotactic propylene polymer cast film line speed

(76) Inventors: Michael A. McLeod, Kemah, TX (US); David Young, Deer Park, TX (US)

Correspondence Address: David J. Alexander;Fina Technology, Inc., P.O. Box 674412, Houston, TX, 77267-4412, US

(21) Appl. No.: 10/699,956

(22) Filed: Nov. 3, 2003

(51) Int. Cl. C08F 110/06

(52) U.S. Cl. 526/351; 264/216; 425/223

(57) ABSTRACT

A method is provided for casting a film of syndiotactic propylene polymer (sPP) at a film line speed of from about 35 to about 200 feet per minute. The sPP provided may include a peak melt temperature of from about 120 to about 140 degrees Celsius. A processing aid may be added to the sPP prior to casting the sPP film. The casting temperature of the method provided may be maintained at less than about 430 degrees Fahrenheit. The method provided includes a cast roll that forms the sPP film and that may be maintained at a temperature of from about 50 to about 130 degrees Fahrenheit. The coefficient of friction of the sPP film provided may be less than about 1.0. The maximum tensile strength of the sPP film provided may be at least about 4,200 pounds per square inch.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

This invention relates to syndiotactic propylene polymer and methods of improving the speed of casting a film thereof.

### BACKGROUND OF THE INVENTION

Syndiotactic propylene polymer (sPP) homopolymer has been commercially produced for several years. Compared to conventional isotactic polypropylene (iPP) homopolymer, sPP is softer, clearer, and possesses a lower melting point. In addition, the commercial sPP homopolymer has a narrower molecular weight distribution than Zigler-Natta catalyst-based iPP. The unique characteristics of sPP not only make it useful in new and existing polypropylene applications, but also present unique processing challenges. As the place of sPP in the commercial market continues to grow, so grows the need to more thoroughly understand the processability of sPP. In particular, processing sPP under conditions normally associated with processing iPP may be problematic. Molten sPP is much more sticky and tacky than molten iPP, which has presented problems when attempting to cast sPP under conditions normally associated with casting iPP. Thus, improved methods for casting sPP are desirable.

### SUMMARY OF THE INVENTION

In an embodiment, a method is provided for casting a film including syndiotactic propylene polymer (sPP) at a film line speed of from about 35 to about 200 feet per minute. In another embodiment, the sPP provided includes a peak melt temperature of from about 120 to about 140 degrees Celsius. In another embodiment, the method of casting an sPP film includes adding a processing aid to the sPP prior to casting the sPP film. In another embodiment, the method of casting an sPP film includes maintaining a casting temperature of less than about 430 degrees Fahrenheit. In another embodiment, the method of casting an sPP film includes casting the sPP film on a cast roll wherein the cast roll is maintained at a temperature of from about 50 to about 130 degrees Fahrenheit. In another embodiment, the sPP film provided includes a coefficient of friction of less than about 1.0. In another embodiment, the sPP film provided includes a maximum tensile strength of at least about 4,200 pounds per square inch. In another embodiment, the sPP film provided includes a haze of greater than about 10 percent. In another embodiment, the sPP film provided includes a 20 degree gloss of less than about 20 percent. In another embodiment, the sPP film provided includes a 45 degree gloss of less than about 90 percent. In another embodiment, the sPP film provided includes a percent elongation of less than about 600 percent.

In an embodiment, an sPP film is provided that is cast at a film line speed of from about 35 to about 200 feet per minute. In another embodiment, the sPP film provided includes an sPP having a peak melt temperature of from about 120 to about 140 degrees Celsius. In another embodiment, the sPP film provided includes a processing aid blended with the sPP prior to the sPP film being cast. In another embodiment, the sPP film provided includes a coefficient of friction of less than about 1.0. In another embodiment, the sPP film provided includes a maximum tensile strength of at least about 4,200 pounds per square inch.

In an embodiment, a system for casting an sPP film is provided that includes sPP, an extruder that receives and melts sPP, and a cast roll that receives melted sPP and forms the sPP film wherein the sPP film is cast on the cast roll at a film line speed of from about 35 to about 200 feet per minute. In another embodiment, the system provided includes a processing aid blended with the sPP prior to casting. In another embodiment, the system provided includes a casting temperature of less than about 430 degrees Fahrenheit. In another embodiment of the system provided, the cast roll is maintained at a temperature of from about 50 to about 130 degrees Fahrenheit.

### BRIEF DESCRIPTION OF THE DRAWINGS

FIG. 1 illustrates an embodiment of a system for casting a syndiotactic propylene polymer blend.

### DETAILED DESCRIPTION OF THE INVENTION

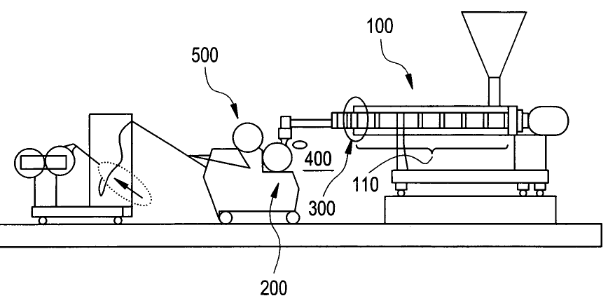

In an embodiment illustrated by a side view in FIG. 1, a system for casting syndiotactic propylene polymer (sPP) is provided. An extruder 100, including a screw barrel 110, receives and melts sPP, and a cast roll 200 receives the melted sPP after extrusion. In addition, the embodiment illustrated by FIG. 1 includes a screen area 300, an air knife 400, and a chill roll 500. The extruder 100 receives and melts the sPP, and feeds the molten sPP through the screen pack 300 to the cast roll 200 via the air knife 400. The casting or melt temperature is controlled and is the temperature in the area downstream of the extruder 100 and upstream of the cast roll 200, which includes the screen area 300 and air knife 400. The cast roll temperature is typically less than the melt temperature, such that the molten sPP is gradually cooling, but not so much as to cause a substantial amount of crystallization as the sPP passes from the extruder 100 to the cast roll 200. A typical commercial casting system, such as that illustrated in the embodiment of FIG. 1, is designed such that the melt temperature, cast roll 200 temperature, and cast roll 200 rotation speed are controlled to form a film of sPP of a controlled thickness as the molten sPP contacts the rotating cast roll 200 and cools. The sPP film wraps on the cast roll 200, which further feeds the film to the chill roll 500 as the film continues to cool and eventually crystallize into a commercial-quality film.

The sPP provided herein possesses unique characteristics that may result in improved cast film properties and require different processing conditions as compared to other propylene polymers. The peak melt temperature of the sPP provided is measured via differential scanning calorimetry according to ASTM D 3418. In an embodiment, the sPP provided possesses a peak melt temperature of from about 120 to about 140 degrees Celsius. In anther embodiment, the peak melt temperature is from about 125 to about 135 degrees Celsius. The melt flow of the sPP as measured according to ASTM D 1238, and the xylene solubles content of the sPP as measured according to ASTM D5492-98 are typical characteristics of concern in the sPP market. In an embodiment, the sPP provided herein possesses a melt flow of from about 0.1 to about 40 grams per 10 minutes according to ASTM D 1238, and a xylene solubles content of from about 0 to about 10 weight percent according to ASTM D5492-98. Table I includes examples of typical commercial embodiments of sPP expressed in terms of melt flow properties and xylene solubles content:

TABLE I

| EXAMPLE | Melt Flow (grams/10 min.) | | Xylene Solubles (weight %) | |
|---|---|---|---|---|
| 1 | Target: | 2.2 | Target: | 3.5 |
| | Minimum: | 1.9 | Minimum: | 2 |
| | Maximum | 2.5 | Maximum: | 5 |
| 2 | Target: | 4.0 | Target: | 3.5 |
| | Minimum: | 3.5 | Minimum: | 2 |
| | Maximum: | 4.5 | Maximum: | 5 |
| 3 | Target: | 12.0 | Target: | 5 |
| | Minimum: | 9.0 | Minimum: | 3 |
| | Maximum: | 15.0 | Maximum: | 7 |
| 4 | Target: | 20 | Target: | 6 |
| | Minimum: | 16 | Minimum: | 4 |
| | Maximum: | 24 | Maximum: | 8 |

Polymer processing aids, or additives, are generally known to help reduce melt fracture and associated surface defects in polypropylene, as well as make other improvements in polymer processability. Processing temperatures provided herein reduce polymer tackiness and buildup on equipment, but may increase the occurrence of melt fracture. Adding a processing aid to the sPP provided herein generally reduces the occurrence of melt fracture, and in combination with cooler processing temperatures allows for successful and significant increases in film line speed as provided herein. In an embodiment, the processing aid provided comprises a fluoropolymer. In another embodiment, the processing aid comprises a fluoroelastomer. Examples of processing aids provided herein available commercially include Viton Freeflow, which is manufactured by DuPont Dow Elastomers of Wilmington, Del., and Dynamar, which is manufactured by Dyneon of Oakdale, Minn. The additive is blended with sPP prior to casting the sPP film. In an embodiment, the concentration of processing aid added to the sPP is from about 0 to about 3,000 parts per million by weight. In another embodiment, the concentration of processing aid is from about 100 to about 1,500 parts per million by weight. In another embodiment, the concentration of processing aid is from about 900 to about 1,100 parts per million by weight.

Referring again to FIG. 1, where the downstream flow of sPP is from the extruder 100 through the screen area 300 and air knife 400 to the cast roll 200, the casting temperature of the present method is the temperature upstream of the cast roll 200 and downstream of the extruder 100. For purposes of the present application, the casting temperature may also be known as the melt temperature, or, if extrusion occurs prior to casting, the temperature after the extruder. In combination with controlling cast roll temperature, controlling melt or casting temperature prevents sPP from sticking to the casting equipment, such as the cast and chill rolls, and allows higher film line speeds. Generally when processing polymers, the necessary melt temperature is dependent on the peak melt temperature of the polymer, and is typically lower than the extrusion temperature, yet higher than the cast roll temperature such that the polymer experiences gradually cooler temperatures as it flows downstream. A lower melt temperature may also mean less time for equipment warm-up and, therefore, potentially less equipment down time. In an embodiment, casting temperature is maintained at less than about 430 degrees Fahrenheit. In another embodiment, casting temperature is maintained at less than about 350 degrees Fahrenheit. In another embodiment, casting temperature is maintained at less than about 300 degrees Fahrenheit.

Molten sPP is received by and forms a film on a cast roll. The temperature and speed of the cast roll, among other things, affect processability and characteristics of the cast film. The temperature of the cast roll is controlled to this end, and in particular may affect whether the polymer sticks to the roll, and the cooling time of the cast film. In general, the cast roll temperature is cooler than the processing zones upstream of the cast roll, such that the sPP is continuously cooling as it passes from the extrusion temperature to the casting temperature to the cast roll temperature. In an embodiment, cast roll temperature is maintained from about 50 to about 130 degrees Fahrenheit. In another embodiment, cast roll temperature is maintained from about 70 to about 120 degrees Fahrenheit. In another embodiment, cast roll temperature is maintained from about 90 to about 110 degrees Fahrenheit.

Referring again to FIG. 1, the film line speed provided may be defined as the rate, such as in feet per minute, at which the sPP film is cast on the rotating cast roll 200. Molten sPP contacts the cast roll 200, which is rotating at a controlled speed. The system and method provided herein are designed such that the molten sPP forms an sPP film on the rotating cast roll 200. The film wraps around the cast roll 200 and is passed to the chill roll 500. The sPP film similarly wraps around the chill roll 500, which is similarly rotating and further chills and forms the sPP film. Increasing film line speed is generally desirable because it results in increasing product output. Impediments to increasing line speed may arise in the form of, for example, melt fracture in the cast film, sPP adhering to and wrapping around the cast roll 200, rather than peeling off, as it is transferred to the chill roll 500, or, to a less degree than adhering to and wrapping around the cast roll, excessive buildup of polymer on the cast roll requiring a disproportionate amount of equipment cleanup and down time. The combination of lowering casting temperature and adding processing aid provided herein permits significant increases in film line speed. In an embodiment of the method provided, casting a film of sPP occurs at a film line speed of from about 35 to about 200 feet per minute. In another embodiment, casting a film of sPP occurs at a film line speed of from about 70 to about 150 feet per minute. In another embodiment, casting a film of sPP occurs at a film line speed of from about 90 to about 120 feet per minute.

The methods provided herein affect the coefficient of friction of an sPP film. The tackiness of the sPP film may be related to the coefficient of friction. In general, the coefficient of friction, and film tackiness, may decrease with cooler casting temperatures. In an embodiment of the sPP film provided, the film possesses a coefficient of friction of less than about 1.0. In another embodiment, the sPP film possesses a coefficient of friction of less than about 0.7. In another embodiment, the sPP film possesses a coefficient of friction of less than about 0.4. The coefficients of friction provided are as measured according to ASTM D 1894 employing a Merlin 5500 Instrom and software, a sled, board, 500 gram load cell, and a 500 gram weight.

Another characteristic of an sPP film affected by the methods provided herein is tensile strength. Generally, lower casting temperatures may yield stronger sPP films. In an embodiment of the sPP film provided, the film possessed a maximum tensile strength of at least about 4,200 pounds per square inch. In another embodiment, the film possessed a maximum tensile strength of at least about 5,000 pounds per square inch. In another embodiment, the film possessed a maximum tensile strength of at least about 6,000 pounds per square inch. The tensile strengths provided herein are as measured according to ASTM D 882 employing a Merlin 5500 Instrom and software mounted with a 100 N load cell.

The methods provided herein may impact other physical properties of the sPP film. As an example, the sPP film's thermal cooling profile, which is related to casting and cast roll temperatures, among other things, may influence film gloss and haze. Many market applications require specific optical properties, so knowledge of the relationship between processing conditions and these properties is valuable. Generally, faster quenching produces a glossier and less hazy film. In an embodiment of the method provided, the 20 degree gloss value of the cast film is less than about 20 percent. In another embodiment, the 45 degree gloss value is less than about 90 percent. The gloss values provided herein are as measured according to ASTM D 2457 employing a HunterLab Model D48-7 Glossmeter. In another embodiment, the haze of the cast film is greater than about 10 percent. The haze values provided herein are as measured according to ASTM D 1003 employing a Gardner-Neotec Model XL-211 Hazemeter.

Another example of the effects of lower casting temperature is reflected in the percent elongation of the cast sPP film provided. Generally, the percent elongation of the cast sPP film may drop as casting temperature decreases. In an embodiment, the percent elongation associated with the methods and films provided herein is less than about 600 percent.

The desired thickness of the films provided herein may affect processing conditions and film characteristics. For example, thicker films may require more cooling time and slower line speeds. Desired film thickness may be determined by the ultimate use of the film. In an embodiment, the thickness of the sPP film provided herein is from about 0.5 to about 6 mils. In another embodiment, the thickness of the sPP film is from about 1 to about 5 mils. In another embodiment, the thickness of the sPP film is from about 2 to about 4 mils thick.

While the present invention has been illustrated and described in terms of particular apparatus and methods of use, it is apparent that equivalent techniques and ingredients may be substituted for those shown, and other changes can be made within the scope of the present invention as defined by the appended claims.

The particular embodiments disclosed herein are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method comprising:
casting a film comprising syndiotactic propylene polymer (sPP) at a film line speed of from about 35 to about 200 feet per minute.

2. The method of claim 1 wherein said film line speed is from about 70 to about 150 feet per minute.

3. The method of claim 1 wherein said film line speed is from about 90 to about 120 feet per minute.

4. The method of claim 1 further comprising maintaining a casting temperature of less than about 430 degrees Fahrenheit.

5. The method of claim 1 further comprising maintaining a casting temperature of less than about 350 degrees Fahrenheit.

6. The method of claim 1 further comprising maintaining a casting temperature of less than about 300 degrees Fahrenheit.

7. The method of claim 1 wherein said casting occurs on a cast roll, and wherein said cast roll is maintained at a temperature of from about 50 to about 130 degrees Fahrenheit.

8. The method of claim 7 wherein said cast roll is maintained at a temperature of from about 70 to about 120 degrees Fahrenheit.

9. The method of claim 7 wherein said cast roll is maintained at a temperature of from about 90 to about 110 degrees Fahrenheit.

10. The method of claim 1 wherein said sPP comprises a peak melt temperature of from about 120 to about 140 degrees Celsius.

11. The method of claim 1 further comprising adding a processing aid to said sPP prior to casting.

12. The method of claim 11 wherein the concentration of said processing aid in said sPP is from about 0 to about 3,000 parts per million by weight of sPP.

13. The method of claim 11 wherein the concentration of said processing aid in said sPP is from about 100 to about 1,500 parts per million by weight of sPP.

14. The method of claim 11 wherein the concentration of said processing aid in said sPP is from about 900 to about 1100 parts per million by weight of sPP.

15. The method of claim 11 wherein said processing aid comprises a fluoropolymer.

16. The method of claim 11 wherein said processing aid comprises a fluoroelastomer.

17. The method of claim 11 wherein said film comprises a coefficient of friction of less than about 1.0.

18. The method of claim 11 wherein said film comprises a coefficient of friction of less than about 0.7.

19. The method of claim 11 wherein said film comprises a coefficient of friction of less than about 0.4.

20. The method of claim 11 wherein said film comprises a maximum tensile strength of at least about 4,200 pounds per square inch.

21. The method of claim 11 wherein said film comprises a maximum tensile strength of at least about 5,000 pounds per square inch.

22. The method of claim 11 wherein said film comprises a maximum tensile strength of at least about 6,000 pounds per square inch.

23. The method of claim 11 wherein the haze of said film is greater than about 10 percent.

24. The method of claim 11 wherein the 20 degree gloss of said film is less than about 20 percent.

25. The method of claim 11 wherein the 45 degree gloss of said film is less than about 90 percent.

26. The method of claim 11 wherein the percent elongation of said film is less than about 600 percent.

27. The method of claim 1 wherein said film is from about 0.5 to about 6 mils thick.

28. The method of claim 1 wherein said film is from about 1 to about 5 mils thick.

29. The method of claim 1 wherein said film is from about 2 to about 4 mils thick.

30. A syndiotactic propylene polymer (sPP) film cast at from about 35 to about 200 feet per minute.

31. The sPP film of claim 30 wherein said film comprises sPP.

32. The sPP film of claim 31 further comprising a processing aid blended with said sPP prior to said film being cast.

33. The sPP film of claim 32 wherein the concentration of said processing aid in said sPP is from about 0 to about 3,000 parts per million by weight of sPP.

34. The sPP film of claim 30 wherein said sPP comprises a peak melt temperature of from about 120 to about 140 degrees Celsius.

35. The blend of claim 32 wherein said film comprises a coefficient of friction of less than about 1.0.

36. The blend of claim 32 wherein said film comprises a maximum tensile strength of at least about 4,200 pounds per square inch.

37. A system for casting a syndiotactic propylene polymer (sPP) film comprising:
sPP;
an extruder that receives and melts said sPP; and
a cast roll that receives the melted sPP and forms said sPP film;
wherein casting said sPP film occurs on said cast roll at a film line speed of from about 35 to about 200 feet per minute.

38. The system of claim 37 further comprising a processing aid blended with said sPP prior to casting.

39. The system of claim 37 further comprising a casting temperature of less than about 430 degrees Fahrenheit.

40. The system of claim 37 further comprising a casting temperature of less than about 350 degrees Fahrenheit.

41. The system of claim 37 further comprising a casting temperature of less than about 300 degrees Fahrenheit.

42. The system of claim 37 wherein said cast roll is maintained at a temperature of from about 50 to about 130 degrees Fahrenheit.
